(19) United States
(12) Patent Application Publication
(10) Pub. No.: US 2024/0361764 A1
(43) Pub. Date: Oct. 31, 2024

(54) AUTONOMOUS TRUCK LOADING OR UNLOADING FOR MINING AND CONSTRUCTION APPLICATIONS

(71) Applicant: Robotic Research OpCo, LLC, Clarksburg, MD (US)

(72) Inventors: Alberto Daniel LACAZE, Potomac, MD (US); Karl Nicholas MURPHY, Cocoa Beach, FL (US)

(21) Appl. No.: 18/765,949

(22) Filed: Jul. 8, 2024

Related U.S. Application Data
(63) Continuation-in-part of application No. 18/132,539, filed on Apr. 10, 2023, now Pat. No. 12,085,940.
Application No. 18/132,539 is a continuation of application No. 16/676,544, filed on Nov. 7, 2019, now Pat. No. 11,656,626.
(63) Continuation-in-part of application No. 16/676,666, filed on Nov. 7, 2019.
(60) Provisional application No. 62/759,963, filed on Nov. 12, 2018.
(60) Provisional application No. 62/759,965, filed on Nov. 12, 2018.

(51) Int. Cl. G05D 1/00; B60W 60/00; B66F 9/06; B66F 9/075; E02F 9/26; E21F 5/02

(52) U.S. Cl. CPC G05D 1/0212; B60W 60/0011; B60W 60/0027; B66F 9/063; B66F 9/0755; E02F 9/261; E21F 5/02

(57) ABSTRACT

A system can have a database that stores a plurality of behaviors for various operational phases of an autonomous truck. The stored behaviors can include predetermined maneuvers for the autonomous truck, sensing behaviors, and logic behaviors. An operator can select one or more of the stored behaviors via a user interface. A controller can control the autonomous truck to perform the selected behaviors, for example, by assembling the selected behaviors together into an operation script. In some embodiments, performance of the selected behaviors can be used to load the autonomous truck.

### CROSS-REFERENCE TO RELATED APPLICATION(S)

The present application is a continuation-in-part of U.S. patent application Ser. No. 18/132,539, filed Apr. 10, 2023, which is a continuation of U.S. patent application Ser. No. 16/676,544, filed Nov. 7, 2019, now U.S. Pat. No. 11,656,626, issued May 23, 2023, which claims benefit of and priority under 35 U.S.C. § 119 (e) to and is a non-provisional of U.S. Provisional Patent Application No. 62/759,963, filed Nov. 12, 2018, each of which is hereby incorporated by reference herein in its entirety.

The present application is also a continuation-in-part of U.S. patent application Ser. No. 16/676,666, filed Nov. 7, 2019, which claims benefit of and priority under 35 U.S.C. § 119 (e) to and is a non-provisional of U.S. Provisional Patent Application No. 62/759,965, filed Nov. 12, 2018, each of which is hereby incorporated by reference herein in its entirety.

### FIELD

The present disclosure relates generally to autonomous systems, and, more specifically, to autonomous truck loading and/or unloading for mining and construction applications.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND

A number of autonomous trucks are being developed for the mining and construction industries. Much of the automation concentrates on the excavators, and on the autonomous driving of the trucks; however, as of now, not much autonomous function exists for loading and/or unloading the trucks.

Trucks in a mine or construction site move dirt, ore, and other matter from one location to another. The ore is usually loaded by an excavator or a loader. In manned vehicles, there is a sequence of coordinated maneuvers as part of the loading process. These coordinated maneuvers include tasks that are performed with the truck, and tasks that are performed solely with the attached excavator or loader. Currently, the humans performing the tasks have a relatively small amount of sensors helping them, but there are also many techniques that the loading operator uses intuitively:
The loader may distribute the load differently if the truck has to climb or descend on the route;
The loader may load less amount if the terrain is challenging for the driver;
In cases where the truck has multiple trailers, the loader may load the trailers differently; The loader may load the truck differently, depending on the truck type;
The loader may load the truck differently depending on the bay in the truck: i.e., hopper vs. u-section body vs. rock reinforced body;
The loader may first place large rocks in specific areas, and smaller rocks in adjacent areas, to “lock in” the larger rocks;
The loader may load the truck differently if the load is wet, or if the load is a slurry;
The loader may load the truck differently if the truck is a side dump, back dump, or bottom dump truck.

On the loader side, the loading procedure is also significantly affected by the machinery being used. For example, an excavator will follow a different procedure than a front-end loader, and a feeder may require significantly different maneuvers.

For each of these alternatives, there are slightly different loading techniques that are used, both by the truck driver and by the loader. All these peculiarities of the problem are learned with experience and (to a certain degree) with some trial and error on the job. In order to automate the process, this knowledge needs to be explicitly encoded as part of the automation process.

Once at an unloading destination, the truck needs to determine where to unload the ore, dirt, or matter. Different applications require the load to be dumped in different manners. For example:
The load may be all dumped in one area, or it may be more desirable to dump it over larger areas to spread the load;
The truck may dump the load off the side of a hill; The truck may want to fill a hole using the unloaded matter;
The truck may need to dump the load in a particular area, which is then automatically connected with a conveyor belt to another location;
The truck may only be allowed to dump in certain areas and not others;
The truck may want to dump in low areas of the terrain, in order to level the dumping area;
The truck may be approved to dump over water, or over areas that are wet.

These behaviors change significantly depending on the application, and also depending on the capabilities of the truck. For example, some trucks are capable of controlling their back gate, in order to control the spread of the load. Some trucks are side dumpers, while others are back or bottom dumpers. Procedures for organizing this process depend on the vehicle, application, and geography. This is because the area where the matter is being dropped, is usually being modified from one load to the next, posing challenges for automation. Maintaining these areas in an organized way increases the efficiency of the mine, as well as minimizes accidents and vehicle wear and tear.

For each of these applications, there are slightly different dumping techniques that are used by the truck driver. These particular techniques, and the problems associated with them, are learned with experience, and (to a certain degree) with some trial and error on the job. In order to automate the process, this knowledge needs to be explicitly encoded as part of the automation process.

### SUMMARY

To minimize the limitations in the prior art, and to minimize other limitations that will be apparent upon reading and understanding the present specification, the present disclosure describes autonomous truck loading and/or unloading for mining and construction applications.

In some embodiments, a set of tools are provided that allow for the automation of the loading and/or unloading process. In some embodiments, knowledge is encoded into a database of preferred behaviors and/or loading conditions and creates a set of automated maneuvers that accomplish these actions. In some embodiments, the set of automated behaviors can simplify the process of the loading and/or unloading process, for example, shaping of the dumping area.

In some embodiments, the truck has a drive-by-wire kit and is capable of moving under computer control. In some embodiments, the truck may be autonomous, and the excavator may not be autonomous. In other embodiments, both the truck and the excavator are autonomous.

### BRIEF DESCRIPTION OF THE DRAWINGS

Elements in the figures have not necessarily been drawn to scale in order to enhance their clarity and improve understanding of these various elements and embodiments of the disclosed subject matter. Furthermore, elements that are known to be common and well understood to those in the industry are not depicted in order to provide a clear view of the various embodiments of the disclosed subject matter.

FIG. 1 illustrates the use of sensors to detect the location and road, vehicle, pedestrians which are compared to a road network and maneuver database which goes to a controller/autonomous driver which takes into account other vehicle locations and status and is connected to drive by wire which has steer, brake, and throttle, connected with actuators to the truck;

FIG. 2 illustrates paths and locations that can be specified by manually driving the vehicle, by remote driving, or by a route planner;

FIG. 3 shows that as the excavator loads material, the pile will reduce in size. The excavator will have to change position and the “dock” location will change as well;

FIG. 4 illustrates multiple trucks that can be used with an excavator loading to the left and then to the right;

FIG. 5 illustrates scripting language that allows various maneuvers to be combined into different behaviors;

FIG. 6 illustrates the dumping in an area in which the operator specifies the dumping areas and access road;

FIG. 7 illustrates dumping on a grade where an area is to be filled to a specified elevation profile; and

FIG. 8 illustrates dumping on a cliff where the dump site is at the edge of the cliff is specified.

### DETAILED DESCRIPTION

The system is composed of a number of sensors that can be placed both on the loader, on the truck, or in the mining or construction area. By describing the maneuver, we can teach the different automation steps. The process of loading can be divided into three distinct phases: alignment/docking, loading, and departure.

In some embodiments, a series of tools and behaviors are provided that can be used in each one of these phases. In some embodiments, a scripting language can allow for a mining/construction operator to modify and customize the process at each step:
Alignment/Docking Phase. At the beginning of the phase, the truck is likely to be empty, and it must automatically maneuver its hopper or cargo bay into an area that is convenient for the loader to load. Many aspects here are important: the truck must be in a safe pose, the hopper (or at least the area of the bay that the first scoop will be placed) must be within the workspace of the loading system, and usually loaders prefer that the truck be at tangential or normal angles with respect to the loading implement. This alignment simplifies the process of moving the buckets and minimizes the chances of collisions between the bucket and the truck. The desired alignment and the relative pose between the truck and the loader are inputs to the invention. The invention can automatically generate the trajectories that align/dock the truck to the loading area.
Loading Phase. Depending on the complexity of the operation, the loading may or may not require the truck to move during the process. For example, if the truck has multiple trailers, it will most likely be necessary to load one trailer (or a part of a trailer) and then move the truck to a new position that is within the reach of the workspace of the loader. Once again, the process is significantly different depending on the type of loader used. For example, if the loading is being performed with a bucket loader, the loader may move while the truck remains static throughout the process. However, if the loading is performed with an excavator, it is easier to have the truck move and the excavator to be static. Movement of the truck is coordinated with the movement of the bucket, so that the bucket will not collide with any part of the truck. The invention provides a set of aids and a scripting language that allows a mining or construction operator to design the maneuver. The truck can then perform the maneuver automatically.
Departure Phase. Similar to the alignment phase, the trucks must leave the loading area in a safe manner and without driving over areas that are off limits or could be dangerous. The invention allows the mining/construction operator to design a maneuver that is suitable for the particular details of the loading area. These maneuvers are instantiated in a scripting language that allows the operator to add/modify/delete these maneuvers.

Depending on the type of mining operation or construction needs, it is not uncommon for the particulars of the loading area to change often. The scripting language has to be sufficiently streamlined where these maneuvers can either be learned or scripted in a relatively simple way.

In some embodiments, the maneuvers in each of the phases above can be driven (or teleoperated) by an operator, and then have the system “replay” that maneuver. The scripting language can use these learned trajectories and concatenate them into new more complex maneuvers.

The scripting language allows the mine operators to assemble and compose new autonomous vehicle behavior. In this particular case, the behavior in focus is the loading of the autonomous truck.

In some embodiments, the scripting language can be a graphical user interface, where blocks in the display represent the elementary behavior upon which more complex behavior is built upon.

In particular, the scripting language has behavior blocks, sensing blocks, and logic blocks. Some of the blocks can be learned. For example, the operator may choose to record a trajectory. This trajectory becomes a behavior block. Now, the operator can link two or more of these behaviors to create a more complex behavior. The sensor blocks allow the operator to concatenate behavior until a particular sensor (or combination of sensors) achieve a certain value.

For example, let's say that the mine operator would like to create a new loading behavior. He/she can take a behavior block that encapsulates the motion of the truck to the loading area. Then, he/she can use the behavior block that positions the middle of the truck perpendicular to the excavator tracks. Next, he/she can use a sensing block and a logic block that forces the truck to stay in that position, until the truck is loaded and the excavator arm is out of the way. Finally, the operator can concatenate another behavior block that has the truck undock and go to the dumping area. In some embodiments, the scripting language is hierarchical, in the sense that more complex behaviors can be encapsulated by using simpler blocks. In some embodiments, a visual language can be used, as it is simpler to understand by the mining operators; however, other embodiments may have other scripting languages that are not visual and use text to describe the sequences of actions.

There are distinct steps on setting up the system:
The mine operator records segments of trajectories that will be used to assemble the loading procedure. These may include positioning the truck at different locations, performing k-turns, and other maneuvers relevant to the three phases of loading presented above.
The mine operator uses these recorded blocks in the scripting language editor to assemble the loading maneuver and to synchronize the operation with the excavator or loader.
The mine operator can use the built-in simulator that simulates the behavior of the script.
The scripts are loaded to the truck, and/or loaded.
The scripts are executed.

In some embodiments, the system includes a variety of behaviors that can be customized for the particular mining or construction site. In some embodiments, the behaviors are organized in a graphic scripting language that allows the mining/construction operator to assemble more complicated behaviors tailored for the particular site. In some embodiments, the behaviors can be “recorded” by actually driving/teleoperating the truck, or they are prestored in a database.

In some embodiments, the following behaviors can be already pre-programmed:
Dumping in an area. The operator will mark on the interface the dumping area with a polygon (or other marking mechanism, i.e., splines, or list of pixels). The operator will also specify the preferred order within the dumping area. For example, from north to south, etc. This behavior will automatically create routes for the autonomous truck, allowing it to position the dumping area adjacent to the previous dumped pile, while maintaining the directionality provided. Once the area has been finished, most operations use a grader to compact, and/or smooth the surface of the dumping area before the next layer is added.
Dumping on a grade. Like the Dumping on an area, in this behavior, the operator defines an area to be dumped; then, rather than defining a particular preferred dumping direction, the operator defines a particular grade of the dumping area. The area does not need to be planar; it can be provided in a variety of 3D representation mechanisms. In some embodiments, the system then automatically finds the next dumping area, which will automatically get closer to the desired fill level, while not “locking the trucks in.” Planning for this can be accomplished in a variety of ways. In some embodiments, the system uses a convex hull of previous piles, and only assigns destinations that are at the periphery of the growing hull, while warrantying achievability to the exposed surfaces of the hull. This warranties that trucks will not get locked into situations where they cannot reach areas of the pile.
Dumping of a cliff. Under many scenarios, the mining operator may be interested in dumping the debris off a cliff. To undertake this operation, the operator will define the approximate cliff line and the system will create a trajectory that will align the truck perpendicularly to the cliff line. It will then control the vehicle so as to expose the hopper off the border of the cliff, while maintaining a margin of safety. In some embodiments, the autonomous system will use a LADAR, stereo pair, or other ranging sensor to find the edge of the cliff
Dumping along a line. Similar to the Dumping in an area behavior, in this case, the operator defines a line of sequences of lines. This behavior is used for shoring roads, or for making embankments, as well as to create water features. This behavior is also used for distributing dirt along the road to simplify the job of a grader. The operator can choose to determine the line, as well as the intervals at which he/she will prefer the piles to accumulate. The behavior allows the system to also determine partial loads, if the dumping mechanism allows for this process.
Dumping on a pile. The operator specifies the center of the pile, and the truck will automatically dump in the area of the pile that is closest to the center of the pile (provided by the operator) that is still reachable.
Coating a road or area. The operator identifies a road and an area, and the truck will gradually drop the load in the area, attempting to evenly distribute the load. The system will keep track of how much material has been dropped at each part of the assigned area, and automatically route trucks to dump in areas where the specified level of coating has not been achieved.

The scripting language allows the mine operators to assemble and compose new autonomous vehicle behavior. In this particular case, the behavior in question is the unloading of the autonomous truck.

In some embodiments, the scripting language is a graphical user interface, where blocks in the display represent the elementary behavior upon which more complex behavior is built upon.

In some embodiments, the scripting language has behavior blocks, sensing blocks, and logic blocks. Some of the blocks can be learned. For example, the operator may choose to record a trajectory. This trajectory becomes a behavior block. Now, the operator can link two or more of these behaviors to create a more complex behavior. For example, the 3 behaviors presented in the previous subsections are behavior blocks that can be scripted as part of a larger, more complex behavior. The sensor blocks allow the operator to concatenate behavior until a particular sensor (or combination of sensors) achieve a certain value.

For example, let's say that the mine operator would like to create a new unloading behavior. He/she can take a behavior block that encapsulates the motion of the truck to the unloading area, then use the behavior block “Dumping in area.” That behavior will generate a trajectory for the truck to the next needed load. Then, the operator can add a behavior to route from the dumping area to the beginning of the mine road or construction route. Finally, the operator can concatenate another behavior block that has the truck take the mine road or construction route back to the loading area.

In some embodiments, the scripting language is hierarchical, in the sense that more complex behaviors can be encapsulated by using simpler blocks. In some embodiment, a visual language is used, as it is simpler to understand by the mining operators; however, other embodiments may have other scripting language that are not visual and use text to describe the sequences of actions.

The present disclosure describes the development of a system creating and executing loading behavior between a truck and a loader that is comprised of a truck with a drive-by-wire kit, a database of stored maneuvers that are relevant to the phases of the loading process and a controller that executes a series of maneuvers that place the truck within the workspace of the loader, and moves the truck as to facilitate the process of loading.

Alternatively or additionally, the system can increase the safety of mining and construction autonomous trucks that comprise one or more sensors that can detect road features, a drive-by-wire kit installed on an autonomous truck, a planning algorithm that creates trajectories which take the autonomous vehicle from a starting location to a final destination, while at the same time implementing randomizing the trajectory within the traversable road to minimize the ruts or purposely driving over the “high” points of the support surface to flatten the ruts or purposely avoiding (or stopping the vehicle) if a sharp object is detected on the route that can possibly puncture the tires or detecting debris that has been dropped from the truck, to alert other vehicles or itself when driven along the same route or detecting and historically tracking features in the road to determine road movement, and therefore alert to possible collapses or landslides or stopping the vehicle, or avoiding deep water puddles, detected by comparing the water surface and the pre-recorded support surface from a previous pass.

A drive-by-wire kit is a complete hardware and software system that allows seamless electronic control of a vehicle's brake, throttle, steering, and shifting to enable testing for autonomous vehicle applications. In some embodiments, a drive-by-wire kit is the use of electrical or electro-mechanical systems for performing vehicle functions traditionally achieved by mechanical linkages. This technology replaces the traditional mechanical control systems with electronic control systems using electromechanical actuators and human-machine interfaces such as pedal and steering feel emulators. Components such as the steering column, intermediate shafts, pumps, hoses, belts, coolers and vacuum servos and master cylinders are eliminated from the vehicle. This is similar to the fly-by-wire systems used widely in the aviation industry.

In some embodiments, the system can have some or all of the stored maneuvers created by driving the vehicle manually, created by teleoperating the vehicle, or by using a route planner.

In some embodiments, there is a scripting language that allows the mining or construction operator to assemble the maneuver from the different behaviors in this system. In some embodiments, there is a simulator that allows the operator to verify the script.

A scripting or script language is a programming language for a special run-time environment that automates the execution of tasks; the tasks could alternatively be executed one-by-one by a human operator. Scripting languages are often interpreted.

In some embodiments, the different behaviors account for variation of the truck being used, or the loader being used.

In some embodiments, the behaviors use sensors in the truck and/or leader to verify that the loading process has been completed.

In some embodiments, the truck is equipped with weight measuring sensors that can indicate where the maximum load capacity has been reached.

In some embodiments, the maneuvers are different depending on the type of load, or wetness of the load. In some embodiments, the system can be further enhanced with a sensor or sensor located on the loaders, the truck, or in the mining/construction areas (LADAR, stereo pair, cameras, RF beacons, DGPS, acoustic sensors, or RADAR), which provide the autonomous truck with accurate positioning.

In some embodiments, the system has a perception module that uses a LADAR, a stereo pair, or a RADAR. LADAR stands for Laser Detection and Ranging and is a surveying method that measures distance to a target by illuminating the target with pulsed laser light and measuring the reflected pulses with a sensor. Differences in laser return times and wavelengths can then be used to make digital 3-D representations of the target. A stereo camera is type of camera with two or more lenses with a separate image sensor or film frame for each lens. This allows the camera to simulate human binocular vision, and therefore gives it the ability to capture three-dimensional images, a process known as stereo photography. RADAR is Radio Detection and Ranging and is a detection system that uses radio waves to determine the range, angle, or velocity of objects. It can be used to detect aircraft, ships, spacecraft, guided missiles, motor vehicles, weather formations, and terrain.

Laser Detection and Ranging (LADAR) illuminates a target with pulsed or modulated laser light and then measures the reflected energy with a sensor. Differences in laser return times and wavelengths are then used to generate accurate target representations via high-res 3D shape and detailed vibration spectrum data that is as unique as a fingerprint. This data is then compared to an existing database of similar items, and the precision results are instantly conveyed back to the user. Generally, this technology is also known as Light Imaging, Detection, and Ranging (LIDAR).

Stereo pair refers to a pair of flat perspective images of the same object obtained from different points of view. When a stereopair is viewed in such a way that each eye sees only one of the images, a three-dimensional (stereoscopic) picture giving a sensation of depth is perceived.

In navigation, a radio frequency (RF) beacon is a kind of beacon, a device which marks a fixed location and allows direction finding equipment to find relative bearing. Radio beacons transmit a radio signal which is picked up by radio direction finding systems on ships, aircraft, and vehicles to determine the direction to the beacon.

Differential Global Positioning System (DGPS) is an enhancement to the Global Positioning System (GPS) which provides improved location accuracy, in the range of operations of each system, from the 15-meter nominal GPS accuracy to about 1-3 cm in case of the best implementations.

Rayleigh scattering based distributed acoustic sensing (DAS) systems use fiber optic cables to provide distributed strain sensing. In DAS, the optical fiber cable becomes the sensing element and measurements are made, and in part processed, using an attached optoelectronic device. Such a system allows acoustic frequency strain signals to be detected over large distances and in harsh environments.

Radio Detection and Ranging (RADAR) refers to a detection system that uses radio waves to determine the range, angle, or velocity of objects. It can be used to detect aircraft, ships, spacecraft, guided missiles, motor vehicles, weather formations, and terrain.

In some embodiments, the sensors are also used to detect humans, vehicles, and other obstacles, and slows down or stops to avoid collisions. The weight of each trailer in the truck is transmitted to the loader. The weight on each wheel in each of the parts of the truck is transmitted to the trailer.

In some embodiments, the leader and the trucks share localization information that is used as part of the scripting language.

In some embodiments, multiple loaders are used to speed up the process of loading the autonomous trucks.

In some embodiments, the features stored in the world model are shared by multiple vehicles. In this system, a road grader or operator is automatically summoned if the water puddles are too deep to traverse, or deeper than a certain threshold.

In some embodiments, an operator is summoned if the features on the road have moved above a certain threshold (which may indicate that the road could be prone to collapse or landslide). In addition, an operator is summoned if the features on the road have moved above a certain threshold (which may indicate that the road could be prone to collapse or landslide).

In some embodiments, an operator is summoned if a sharp object that can puncture the tires is found.

In some embodiments, an operator is summoned if a certain threshold weight has been dropped from the truck. There is also a radio for transmitting road condition information to other systems equipped with embodiments of the disclosed subject matter, or a centralized monitoring system.

In some embodiments, the raw sensors are on the vehicle, but some of the feature extraction and behavior generation algorithms are located outside of the truck.

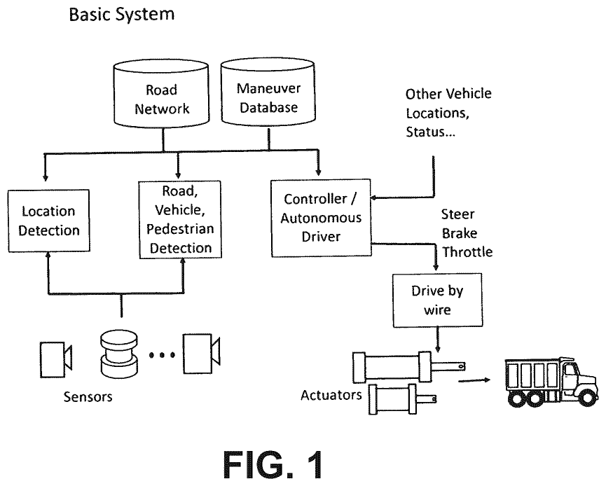

FIG. 1 shows a schematic of the overall basic system for the autonomous trucks for mining and construction applications. Here, the sensors detect the location, road, vehicle, and pedestrians and compares the information to those in the database of the road network and the maneuver database and this information is passed along to the controller/autonomous driver. Information about other vehicles, locations, status, and other information is also passed along to the controller/autonomous driver. The controller/autonomous driver is equipped with drive-by-wire which has steer, brake, and throttle which goes to the actuators and leads to the autonomous truck that is used for the construction and mining applications.

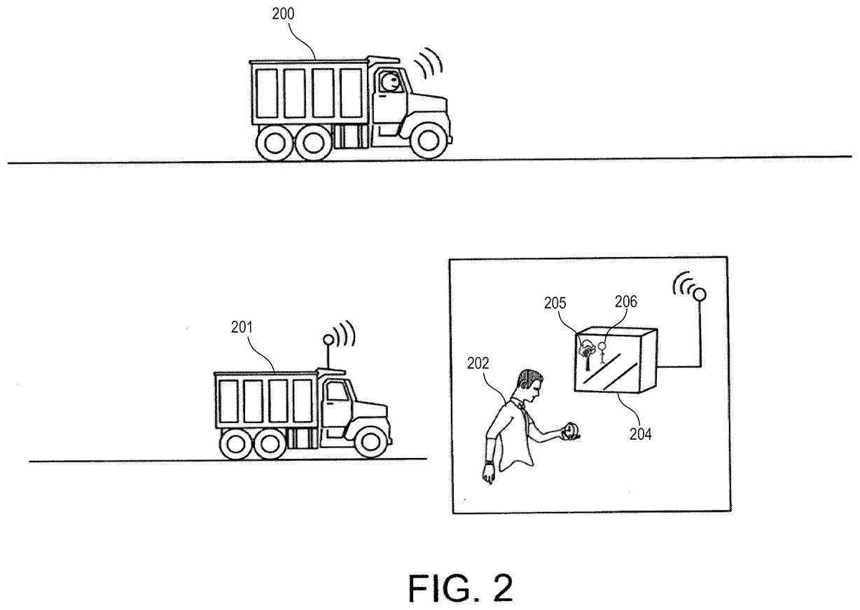

In FIG. 2, it can be seen that the paths and locations can be specified by manually driving the vehicle, by remote driving, or by a route planner. In the top of FIG. 2, it can be seen that the vehicle (200) is manually driven, and in the bottom of FIG. 2, it can be seen that the vehicle (201) is remotely driven by an operator (202). The operator controls the steering wheel on the vehicle (201) on the left based on the view (204) shown containing the tree (205) and the pedestrian (206) standing near the tree (205).

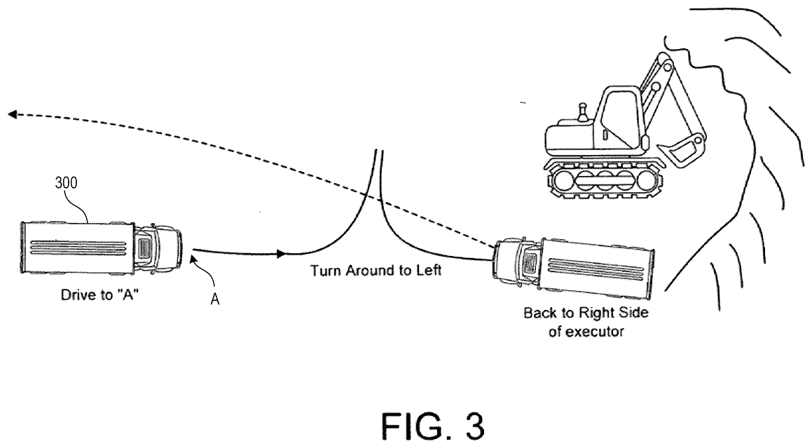

FIG. 3 shows maneuvers to “dock” location such as the position truck at the right side of the excavator. In the figure, the dashed arrow shows the departure path. As the excavator loads material, the pile will reduce in size. The excavator will have to change position and the “dock” location will change as well. In the figure, the autonomous vehicle (300) on the left drives to point “A” and then turns around to the left side. Then it goes back to the right side of the excavator.

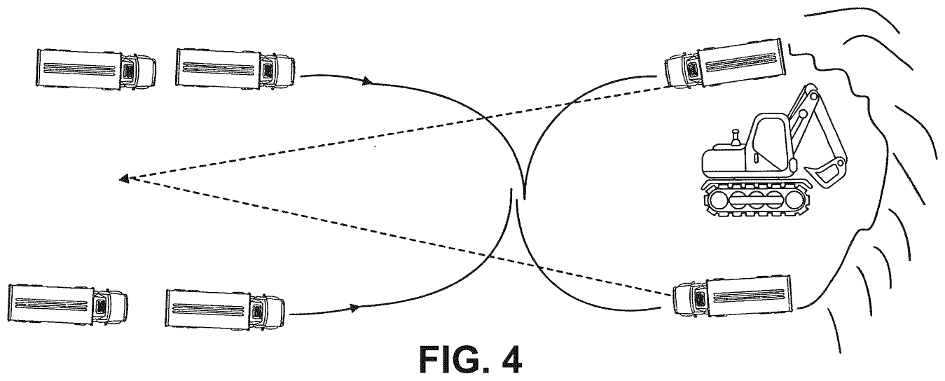

FIG. 4 shows multiple trucks that can be used with the excavator loading to the left and then to the right. When loading the truck on the left, the full truck on the right leaves and is replaced with an empty truck, keeping the excavator constantly loading. Trucks can wait in different queues for their turn to be loaded or for access to area where they can turn around.

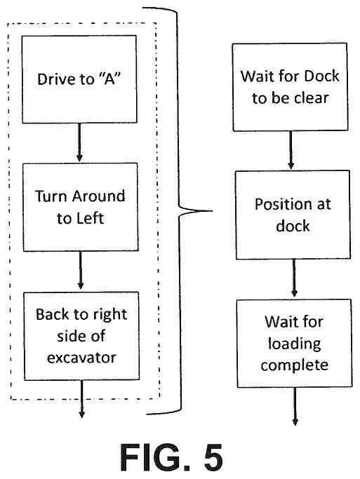

FIG. 5 shows that the scripting language allows various maneuvers to be combined into different behaviors. The commands, drive to “A”, turn around to left, turn back to right side of excavator is related to waiting for the dock to be clear, positioning at the dock, and waiting for loading to be complete.

There is also coordination of multiple trucks that occur in which they wait in queues, wait for the maneuver areas to be clear, and wait for the docking location to be clear.

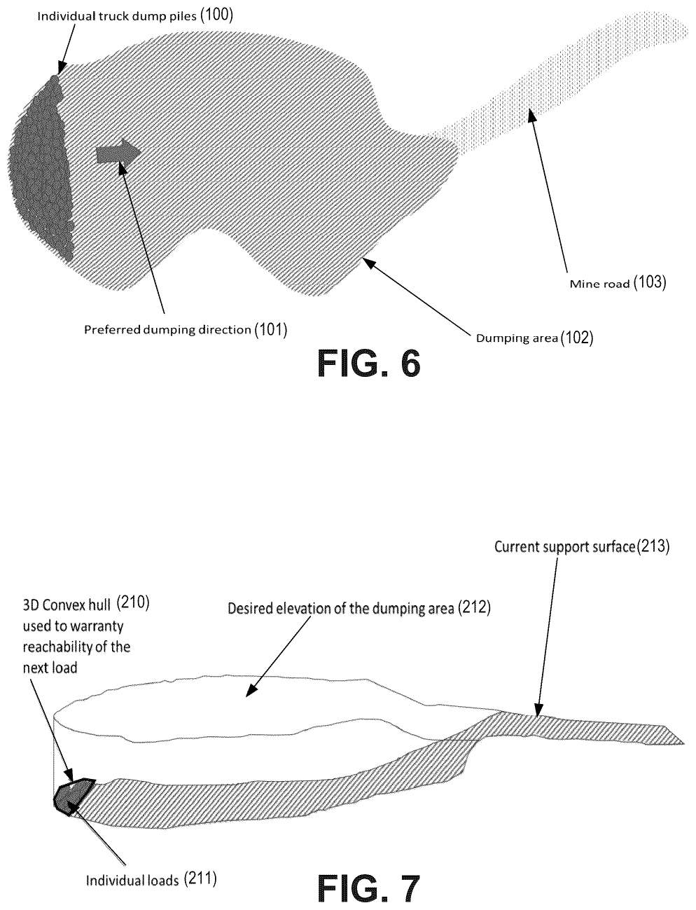

FIG. 6 shows dumping in an area in which the operator specified the dumping area and access road. The operator will also specify the preferred order within the dumping area. In this case, the operator specified from left to right. Each truck unloads next to the pile by the previous truck. When the row reaches the edge of the dumping area, a new row is started. The 3 rows progress from left to right. When the area is filled, the surface is smoothed and the process starts again. A new set of loads is dumped on top of the previous layer. The individual dump piles (100) are indicated on the far left. The preferred dumping direction is also indicated in 101. The dumping area (102) to dump the piles is also shown. On the far right, there is a mine road (103).

FIG. 7 shows dumping on a grade in which an area is to be filled to a specified elevation profile. Due to a potentially uneven initial grade and uneven specified elevation, the final thickness may vary across the area. The system computes a dumping order in z, y, and x so that the area will be filled to the desired elevation while ensuring that each dump location is accessible. The convex hull (210) that is used to warranty reachability of the next load is shown in the far left of the figure. The individual loads (211) are indicated in the left side of the figure. In addition, the desired elevation of the dumping area (212) is also shown in the figure. On the right surface, the current support surface (213) is also shown.

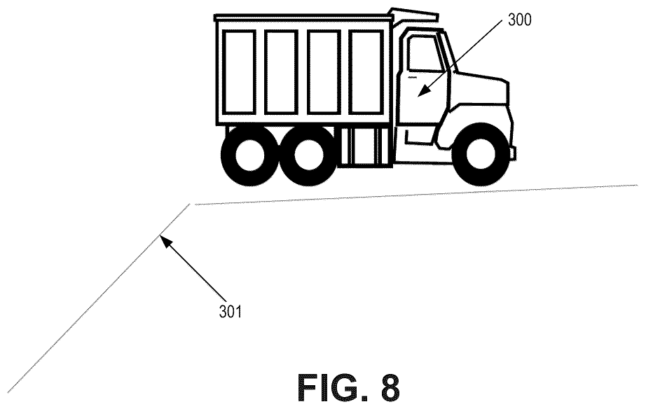

FIG. 8 shows dumping on a cliff in which the dump site at the edge of the cliff is specified. The system computes the position and orientation for the truck to expose the hopper off the border of the cliff, while maintaining a margin of safety. The autonomous truck (300) is located near a cliff (301).

### Rules of Interpretation

Throughout the description herein and unless otherwise specified, the following terms may include and/or encompass the example meanings provided. These terms and illustrative example meanings are provided to clarify the language selected to describe embodiments both in the specification and in the appended points of focus, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments. A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required. Although a product may be described as including a plurality of components, aspects, qualities, characteristics and/or features, that does not indicate that all of the plurality are essential or required. Various other embodiments within the scope of the described invention(s) include other products that omit some or all of the described plurality. A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Neither the Title (set forth at the beginning of the first page of this patent application) nor the Abstract (set forth at the end of this patent application) is to be taken as limiting in any way as the scope of the disclosed invention(s). Headings of sections provided in this patent application are for convenience only, and are not to be taken as limiting the disclosure in any way.

All definitions, as defined and used herein, should be understood to control over dictionary definitions, definitions in documents incorporated by reference, and/or ordinary meanings of the defined terms. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise. Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A reference to “another embodiment” in describing an embodiment does not imply that the referenced embodiment is mutually exclusive with another embodiment (e.g., an embodiment described before the referenced embodiment), unless expressly specified otherwise.

The indefinite articles “a” and “an,” as used herein in the specification and in the claims, unless clearly indicated to the contrary, should be understood to mean “at least one” or “one or more”.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods, as known to those of ordinary skill in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including ten percent (10%) of that value are intended, unless explicitly stated otherwise.

Directions and other relative references may be used to facilitate discussion of the drawings and principles herein, but are not intended to be limiting. For example, certain terms may be used such as “inner,” “outer”, “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same. Similarly, while the terms “horizontal” and “vertical” may be utilized herein, such terms may refer to any normal geometric planes regardless of their orientation with respect to true horizontal or vertical directions (e.g., with respect to the vector of gravitational acceleration).

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining and the like. The term “computing” as utilized herein may generally refer to any number, sequence, and/or type of electronic processing activities performed by an electronic device, such as, but not limited to looking up (e.g., accessing a lookup table or array), calculating (e.g., utilizing multiple numeric values in accordance with a mathematic formula), deriving, and/or defining.

The terms “including”, “comprising” and variations thereof mean “including but not limited to”, unless expressly specified otherwise. As used herein, “comprising” means “including,” and the singular forms “a” or “an” or “the” include plural references unless the context clearly dictates otherwise. The term “or” refers to a single element of stated alternative elements or a combination of two or more elements, unless the context clearly indicates otherwise.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media, such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as ultra-wideband (UWB) radio, Bluetooth™, Wi-Fi, TDMA, CDMA, 3G, 4G, 4G LTE, 5G, etc.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

Embodiments of the disclosed subject matter can be configured to work in a network environment including a computer that is in communication, via a communications network, with one or more devices. The computer may communicate with the devices directly or indirectly, via a wired or wireless medium, such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

### CONCLUSION

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant intends to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the present disclosure.

1. A system for an autonomous truck, the system comprising:
one or more sensors;
a database storing a plurality of behaviors, the stored behaviors comprising elementary behaviors for various phases for loading of the autonomous truck, the stored behaviors comprising (i) a plurality of predetermined maneuvers for the autonomous truck, (ii) a plurality of sensing behaviors, and (iii) a plurality of logic behaviors; and
a controller operatively coupled to the database and the one or more sensors, and being configured to control the autonomous truck,
wherein the controller is operable to execute stored instructions to:
receive, via a user interface, a selection by an operator of a first one of the elementary behaviors from the database, the first selected elementary behavior comprising a sensing behavior that determines a status of loading of the autonomous truck based on signals from the one or more sensors;
receive, via the user interface, a selection by the operator of a second one of the elementary behaviors from the database, the second selected elementary behavior comprising a logic behavior that maintains a state of the autonomous truck until it is determined that the loading of the autonomous truck is complete;
assemble together the first and second selected elementary behaviors to form an operation script for the loading of the autonomous truck; and
control the autonomous truck to perform the operation script for loading.

2. The system of claim 1, wherein the plurality of behaviors stored by the database comprise predetermined behaviors for unloading or dumping by the autonomous truck.

3. The system of claim 2, wherein the controller is further operable to execute stored instructions to:
receive, via the user interface, a selection by the operator of at least one of the predetermined behaviors for unloading or dumping stored by the database; and
control the autonomous truck to perform the selected at least one of the predetermined behaviors at an unloading or dumping location,
wherein material is unloaded or dumped by the autonomous truck at the unloading or dumping location by performing the selected at least one of the predetermined behaviors.

4. The system of claim 3, wherein the one or more sensors are configured to detect features in an environment surrounding the autonomous truck.

5. The system of claim 1, wherein the controller is further operable to execute stored instructions to:
receive, via the user interface, a selection by the operator of a third one of the elementary behaviors from the database, the third selected elementary behavior comprising a predetermined maneuver that defines a trajectory for the autonomous truck to follow to a loading location; and
control the autonomous truck to perform the third selected elementary behavior and to follow the trajectory to the loading location.

6. The system of claim 5, wherein the predetermined maneuver of the third selected elementary behavior comprises a trajectory recorded during previous manual operation of the autonomous truck.

7. The system of claim 5, wherein the controller is further operable to execute stored instructions to, during the control of the autonomous truck to perform the third selected elementary behavior:
receive, from the one or more sensors, a signal indicating detection of an obstacle;
determine, in response to the received signal, one or more variations to the trajectory that avoids a collision with the detected obstacle, the one or more variations comprising a trajectory deviation, a velocity change, or a stoppage of the autonomous truck; and
control the autonomous truck to follow the trajectory with the one or more variations.

8. The system of claim 1, wherein the autonomous truck comprises one or more weight measuring sensors, and the controller is further operable to execute stored instructions to:
determine a weight loaded onto the autonomous truck based on signals from the one or more weight measuring sensors;
compare the determined weight to a maximum load capacity of the autonomous truck; and
send, in response to the comparison indicating that the maximum load capacity has been reached, a signal to stop loading of the autonomous truck.

9. The system of claim 1, wherein the one or more sensors comprises a laser detection and ranging (LADAR) system, stereo pair, cameras, radio frequency (RF) beacons, a differential global positioning system (DGPS), acoustic sensor, radio detection and ranging (RADAR), or any combination of the foregoing.

10. The system of claim 1, wherein:
the autonomous truck comprises a weight measuring sensor for each wheel; and
the controller is further operable to execute stored instructions to:
determine, based on one or more signals from each weight measuring sensor, a current distribution of weight loaded onto the autonomous truck; and
send a signal external to the autonomous truck indicating the current distribution of weight loaded onto the autonomous truck.

11. The system of claim 1, wherein at least one of the one or more sensors is disposed in an environment surrounding the autonomous truck.

12. The system of claim 1, wherein the controller is further operable to execute stored instructions to:
receive, via the user interface, a selection by the operator of a third one of the elementary behaviors from the database, the third selected elementary behavior comprising a sensing behavior that determines a status of a loading area based on signals from the one or more sensors;
receive, via the user interface, a selection by the operator of a fourth one of the elementary behaviors form the database, the fourth selected elementary behavior comprising a logic behavior that maintains a location of the autonomous truck outside of the loading area until the loading area is clear; and
control the autonomous truck to perform the third and fourth selected elementary behaviors.

13. The system of claim 1, wherein the controller is further operable to execute stored instructions to:
receive, via the user interface, a selection by the operator of a third one of the elementary behaviors from the database, the third selected elementary behavior comprising a sensing behavior that detects movement of a loading mechanism based on signals from the one or more sensors;
receive, via the user interface, a selection by the operator of a fourth one of the elementary behaviors form the database, the fourth selected elementary behavior comprising a maneuver that coordinates movement of the autonomous truck with the detected movement of the loading mechanism; and
control the autonomous truck to perform the third and fourth selected elementary behaviors.

14. A system for an autonomous truck, the system comprising:
one or more sensors;
a database storing a plurality of behaviors; and
a controller operatively coupled to the one or more sensors and the database, and being configured to control the autonomous truck,
wherein the controller is operable to execute stored instructions to:
receive, via a user interface, a selection by an operator of at least one first behavior from the stored plurality of behaviors; and
control the autonomous truck to perform the selected at least one first behavior, such that material is dumped or unloaded by the autonomous truck.

15. The system of claim 14, wherein the selected at least one first behavior is dumping in a user-defined area, dumping according to a user-defined dumping area grade, dumping along one or more user-defined lines, dumping with respect to a user-defined pile center, or coating of a user-defined road or area.

16. The system of claim 14, wherein the controller is further operable to execute stored instructions to control the autonomous truck to perform the selected at least one first behavior until a predetermined value is achieved by the one or more sensors.

17. The system of claim 14, wherein the controller is further operable to execute stored instructions to:
receive, via the user interface, a selection by the operator of a second behavior from the stored plurality of behaviors, the selected second behavior comprising a sensing behavior that causes the controller to determine a status of loading of the autonomous truck based on signals from the one or more sensors;
receive, via the user interface, a selection by the operator of a third behavior from the stored plurality of behaviors, the selected third behavior comprising a logic behavior that causes the controller to maintain a state of the autonomous truck until the controller determines that the loading of the autonomous truck is complete; and
control the autonomous truck to perform the selected second and third behaviors, such that material is loaded onto the autonomous truck.

18. The system of claim 14, wherein the controller is further operable to execute stored instructions to:
determine an initial trajectory for the autonomous truck from a first location toward a location for dumping or unloading;
determine a modified trajectory that incorporates randomized deviations from the initial trajectory within a traversable road so as to flatten existing ruts or reduce creation of new ruts in the road; and
control the autonomous truck to follow the modified trajectory toward the location for dumping or unloading.

19. The system of claim 14, wherein the controller is further operable to execute stored instructions to:
receive, via the user interface, input by the operator defining a dumping area, order of dumping, grade of dumping, or cliff line.

20. The system of claim 14, wherein the controller is further operable to execute stored instructions to:
determine, in response to the selection of the at least one first behavior, dumping of the material by the autonomous truck so as to maintain accessibility for subsequent dumping at a location for dumping or unloading.
